(19) United States
(12) Patent Application Publication
(10) Pub. No.: US 2006/0170186 A1
(43) Pub. Date: Aug. 3, 2006

(54) Collapsible bicycle

(76) Inventor: Ho-Hsin Wu, Sindian City (TW)

Correspondence Address: POSZ LAW GROUP, PLC, 12040 SOUTH LAKES DR., SUITE 101, RESTON, VA, 20191, US

(21) Appl. No.: 11/023,350

(22) Filed: Dec. 29, 2004

(51) Int. Cl. B62K 17/00

(52) U.S. Cl. 280/278

(57) ABSTRACT

A collapsible bicycle has a frame assembly and a locking device. The frame assembly has a head tube, a sliding bracket, a downtube and a seat tube. The slidable bracket is mounted around the head tube. The downtube is connected pivotally to the slidable bracket, and the seat tube is connected pivotally to the head tube and the downtube. The locking device connects to the slidable bracket and selectively holds the slidable bracket in position. The slidable bracket moves along the head tube to align the downtube and the seat tube with the head tube. Then the locking device holds the slidable bracket in position to hold the collapsible bicycle in a collapsed state.

### BACKGROUND OF THE INVENTION

1. Field of the Invention

The present invention relates to a bicycle, especially to a collapsible bicycle.

2. Description of the Prior Arts

People who live in big cities can use public transportation such as buses and subways. However, public transportation operates on routes with specific designated stops, which often requires that people who use public transportation walk considerable distances to their destinations. To reduce the time required to walk to a specific destination, some people ride bicycles to cover short distances. However, ordinary bicycles are too large to easily carry on public transportation. Therefore, conventional collapsible bicycles are more commonly taken on public transportation because conventional collapsed bicycles are much smaller. However, to collapsing the conventional collapsible bicycle is complicated and requires time. People who take the public transportation, especially commuters, usually have no time to waste on collapsing conventional collapsible bicycles. After collapsing the conventional collapsible bicycles, the conventional collapsed bicycles are shorter and cannot be rolled easily.

To overcome the shortcomings, the present invention provides a simple and convenient collapsible bicycle to mitigate or obviate the aforementioned problems.

### SUMMARY OF THE INVENTION

The main objective of the present invention is to provide a simple and convenient collapsible bicycle. The collapsible bicycle has a frame assembly and a locking device. The frame assembly has a head tube, a sliding bracket, a downtube and a seat tube. The slidable bracket is mounted around the head tube. The downtube is connected pivotally to the slidable bracket, and the seat tube is connected pivotally to the head tube and the downtube. The locking device connects to the slidable bracket and selectively holds the slidable bracket in position. The slidable bracket moves along the head tube to align the downtube and the seat tube with the head tube. Then the locking device holds the slidable bracket in position to hold the collapsible bicycle in a collapsed state.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible bicycle in accordance with the present invention;

FIG. 2 is an enlarged perspective view of a crankset of the collapsible bicycle in FIG. 1;

FIG. 3 is an enlarged perspective view of a slidable bracket and a locking device of the collapsible bicycle in FIG. 1;

FIG. 4 is a perspective view of the collapsible bicycle in FIG. 1 in a collapsed state; and

FIG. 5 is an enlarged operational front view in partial section of the slidable bracket and the locking device of the collapsible bicycle in FIG. 2.

### DETAILED DESCRIPTION OF THE PREFERRED EMBODIMENTS

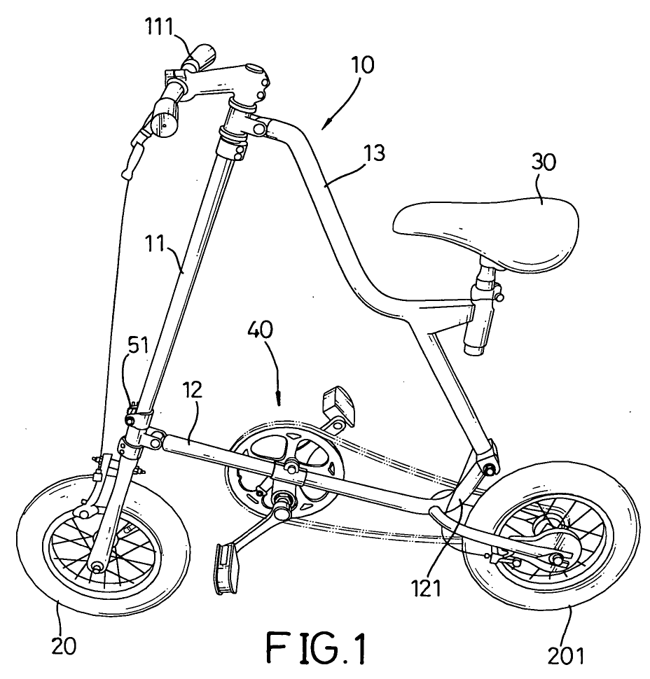

With reference to FIG. 1, a collapsible bicycle in accordance with the present invention comprises a frame assembly (10), a handle bar (111), a front wheel assembly (20), a rear wheel assembly (201), a seat assembly (30), a crankset (40) and a locking device (51).

The frame assembly (10) comprises a head tube (11), a downtube (12) and a seat tube (13).

The head tube (11) has a top end, a bottom end and a slidable bracket (50). The slidable bracket (50) is mounted slidably around the head tube (11).

The downtube (12) is connected pivotally to the head tube (11) and has a front end and a rear end (121). The front end is connected pivotally to the slidable bracket (50).

The seat tube (13) is connected pivotally to the head tube (11) and the downtube (12) and has a top end and a bottom end. The top end of the seat tube (13) is connected pivotally to the head tube (11) near the top end of the head tube (11). The bottom end of the seat tube (13) is connected pivotally to the rear end (121) of the downtube (12).

The handlebar (111) is mounted rotatably in the top end of the head tube (11).

The front wheel assembly (20) is mounted rotatably in the bottom end of the head tube (11).

The rear wheel assembly (201) connects to the rear end (121) of the downtube (12).

The seat assembly (30) connects to the seat tube (13).

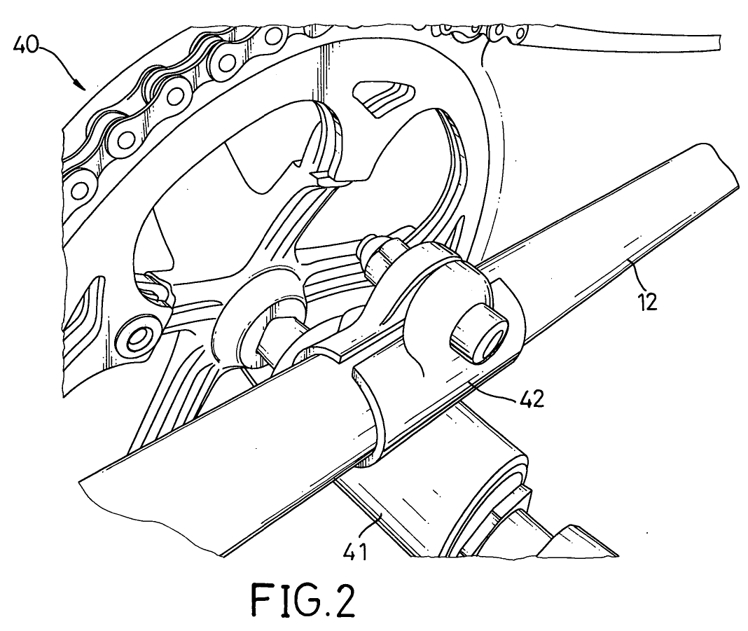

With further reference to FIG. 2, the crankset (40) connects to the downtube (12) and the rear wheel assembly (201), may connect slidably to the downtube (12) and may have a chain wheel, a clamp (42), a crank axle (41) and a chain. The clamp (42) is mounted slidably around the downtube (12). The crank axle (41) is connected to the chain wheel and is attached to the clamp (42). The chain connects to the chain wheel and the rear wheel assembly (201). Sliding the clamp (42) on the downtube (12) tightens or loosens the chain.

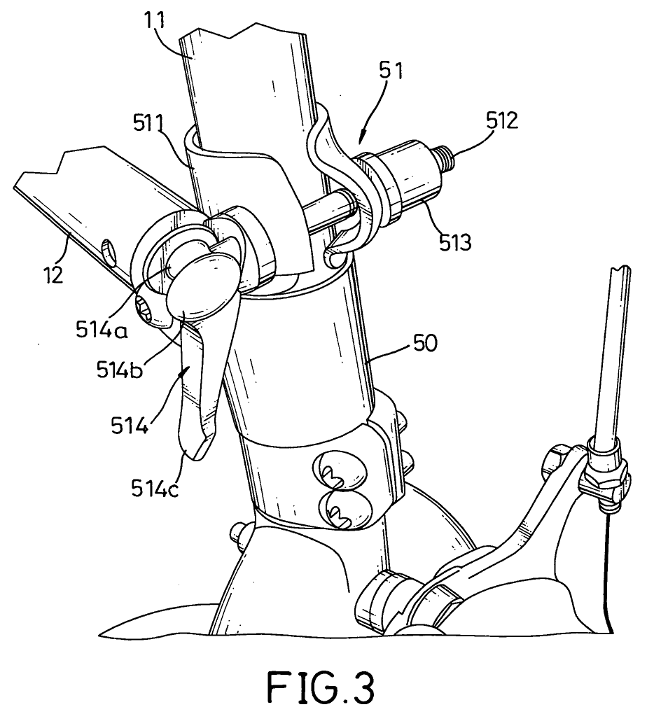

With further reference to FIG. 3, the locking device (51) connects to the slidable bracket (50) around the head tube (11), selectively holds the slidable bracket (50) in position and may comprise a clamp (511), a pin (512), a nut (513) and a lever (514).

The clamp (511) is resilient, connects to the slidable bracket (50), is mounted slidably around the head tube (11) and has an inner surface, two ends and two through holes. The inner surface is mounted around and selectively slides on the head tube (11). The two through holes are formed through the clamp (511) and are opposite to each other respectively near the two ends of the clamp (511).

The pin (512) is mounted slidably through the two through holes in the clamp (511) and has a threaded head and a proximal end.

The nut (513) screws into the threaded head of the pin (512).

The lever (514) is mounted pivotally on the proximal end of the pin (512) to compress the clamp (511) and has a pivot end (514a) and a tab (514c). The pivot end (514a) faces the clamp (511), is mounted pivotally on the distal end of the pin (512) and has an eccentric head with two enlarged lobes (514b). The tab (514c) is formed opposite to the pivot end (514a) and is pivoted selectively upward or downward. When the tab (514c) is pivoted downward, the enlarged lobes (514b) release the clamp (511). When the tab (514c) is pushed upward, the enlarged lobes (514b) press tightly against and compress the clamp (511).

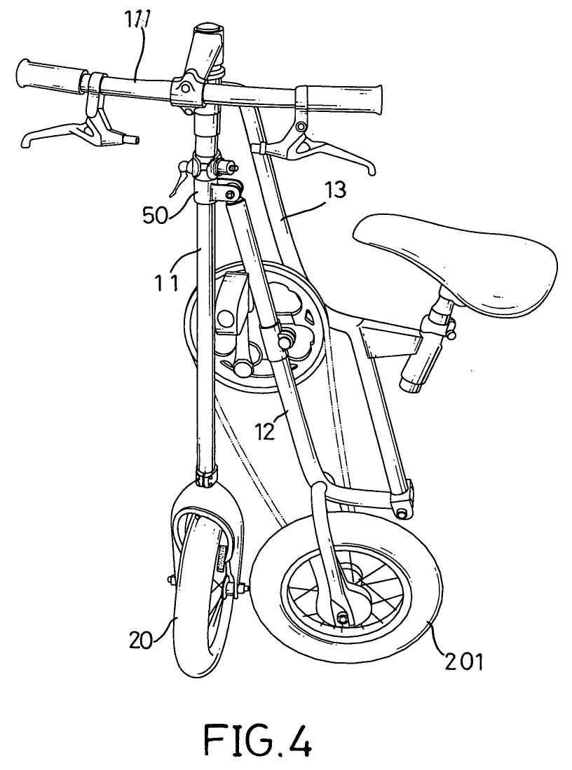

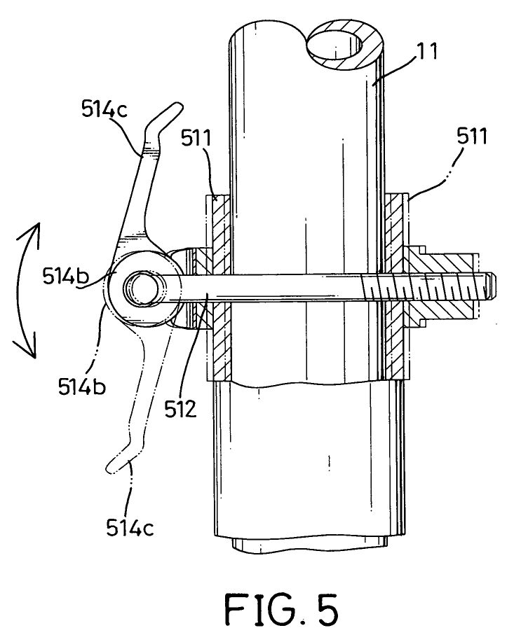

With further reference to FIGS. 4 and 5, the front end of the downtube (12) can be moved upward with the slidable bracket (50) moving along the head tube (11) when the tab (514c) is pivoted downward. The slidable bracket (50) moves upward to align the downtube (12) and the seat tube (13) with the head tube (11). The handlebar (111) is rotated to align the front wheel with the rear wheel. Then the tab (514c) is pivoted upward to press the enlarged lobes (514b) tightly against the clamp (511). When the enlarged lobes (514b) press tightly against the clamp (511), the slidable bracket (50) is held in position. Therefore, the collapsible bicycle is collapsed and is held in a collapsed state.

The collapsible bicycle as described has numerous advantages. The collapsible bicycle is collapsed easily by moving the front end of the downtube (12) up along the head tube (11), rotating the handlebar (111) and pivoting the tab (514c) upward. After collapsing the collapsible bicycle, the collapsible bicycle is still tall enough to move easily.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A collapsible bicycle comprising
a frame assembly comprising
a head tube having
a top end;
a bottom end; and
a slidable bracket mounted slidably around the head tube;
a downtube connected pivotally to the head tube and having
a front end connected pivotally to the slidable bracket; and
a rear end; and
a seat tube connected pivotally to the head tube and the downtube and having
a top end connected pivotally to the head tube near the top end of the head tube; and
a bottom end connected pivotally to the rear end of the downtube;
a handlebar mounted rotatably in the top end of the head tube;
a front wheel assembly mounted rotatably in the bottom end of the head tube;
a rear wheel assembly connecting to the rear end of the downtube;
a seat assembly connecting to the seat tube;
a crankset mounted on the downtube and the rear wheel assembly; and
a locking device connecting to the slidable bracket around the head tube to selectively hold the slidable bracket in position.

2. The collapsible bicycle as claimed in claim 1, wherein
the locking device further comprises
a clamp being resilient, connecting to the slidable bracket, mounted slidably around the head tube and having
an inner surface mounted around and selectively sliding on the head tube;
two ends; and
two through holes formed through the clamp, being opposite to each other respectively near the two ends of the clamp;
a pin mounted slidably through the two through holes in clamp and having
a threaded head; and
a proximal end;
a nut screwing onto the threaded head of the pin; and
a lever mounted pivotally on the proximal end of the pin to compress the clamp and having
a pivot end facing the clamp, mounted pivotally on the proximal end of the pin and having an eccentric head with two enlarged lobes; and
a tab formed opposite to the pivot end and pivoted selectively upward or downward.

3. The collapsible bicycle as claimed in claim 1, wherein
the crankset connects slidably to the downtube and has
a chain wheel;
a clamp mounted slidably around the downtube;
a crank axle connecting to the chain wheel and attached to the clamp; and
a chain connecting to the chain wheel and the rear wheel assembly.

4. The collapsible bicycle as claimed in claim 2, wherein
the crankset connects slidably to the downtube and has
a chain wheel;
a clamp mounted slidably around the downtube; and
a crank axle connecting to the chain wheel and attached to the clamp; and
a chain connecting to the chain wheel and the rear wheel assembly.
